(19) United States
(12) Patent Application Publication
(10) Pub. No.: US 2024/0095785 A1
(43) Pub. Date: Mar. 21, 2024

(54) Intelligent Content-Item Recommendations

(71) Applicant: Valve Corporation, Bellevue, WA (US)

(72) Inventors: Adil Sardar, Seattle, WA (US); Dennis Geels, Kirkland, WA (US); Alden Kroll, Seattle, WA (US); Christen Coomer, Seattle, WA (US); Lakulish Antani, Bellevue, WA (US)

(21) Appl. No.: 17/733,330

(22) Filed: Apr. 29, 2022

(51) Int. Cl. G06Q 30/02

(52) U.S. Cl. CPC G06Q 30/0282; G06Q 30/0201; G06Q 30/0205

(57) ABSTRACT

Described herein are, among other things, techniques, devices, and systems for generating content-item recommendations that are based, at least in part, on data that is unique to respective geographical regions associated with respective users. For instance, the content-item recommendations may be based at least in part on sales data for the respective geographical regions.

### BACKGROUND

As the consumption of content items on electronic devices has continued to proliferate, so has the amount of available content items and information regarding these content items. For example, the number of songs, movies, television shows, and games available for streaming or download has increased substantially in the recent past. While this increase in available content items is generally beneficial to users, identifying content items and information of interest for individual users remains difficult.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a diagram illustrating an example environment that includes multiple client computing devices, operated by respective users residing at different geographical locations. These computing devices couple to a remote computing system configured to provide games and other content items to the client computing devices. In some instances, the computing system may determine sales data that is unique to individual geographical locations associated with the client computing devices and may use this sales data for generating content-item recommendations for respective users.

FIG. 2A illustrates an example user interface (UI) that the remote computing system of FIG. 1 may provide to a first of the client computing devices of FIG. 1 located at a first geographical location. As illustrated, the UI may include content-item recommendations, which may be ordered and/or otherwise based on sales data associated with a region that includes the first geographical location, potentially in addition to one or more other criteria such as preferences or a consumption history of the respective user.

FIG. 2B illustrates another example UI that the remote computing system of FIG. 1 may provide to a second of the client computing devices of FIG. 1 located at a second geographical location. As illustrated, the UI may include content-item recommendations, which may be ordered and/or otherwise based on sales data associated with a region that includes the second geographical location, potentially in addition to one or more other criteria such as preferences or a consumption history of the respective user.

FIG. 3 illustrates a flow diagram of an example process for generating content-item recommendations based on sales data and/or one or more other factors.

FIG. 4 illustrates a flow diagram of an example process for generating game-title recommendations based on sales data and/or one or more other factors.

FIG. 5 illustrates a flow diagram of another example process for generating content-item recommendations based on sales data and/or one or more other factors.

FIG. 6 is a computer architecture diagram showing an example computer hardware architecture for implementing computing devices configured to implement the techniques described herein.

### DETAILED DESCRIPTION

Described herein are, among other things, techniques, devices, and systems for generating content-item recommendations that are based at least in part on data that is unique to respective geographical regions associated with respective users. For instance, the content-item recommendations may be based at least in part on sales data for the respective geographical regions.

In some instances, a remote computing system that offers one or more content items, such as game titles, for acquisition may determine one or more content items associated with a sales event or other promotion. After determining this set of content items, the computing system may present information regarding these items as part of user interfaces (UIs) presented on client computing devices. For instance, upon a client computing device navigating to a webpage or the like associated with the remote computing system, the remote computing system may cause the client computing device to present a UI that includes respective icons associated with the respective content items associated with the sales event or promotion.

In some instances, however, the content items may be selected and/or ordered based on data that is unique to a geographical region associated with the client computing device. For example, a first user may operate a first client computing device to navigate to a webpage provided by the remote computing system or may otherwise request content from the remote computing device for presentation on the first client computing device. Upon receiving the request for content (e.g., in the form of the request for the webpage), the remote computing system may first determine a geographical location associated with the first client computing device. For instance, the computing system may determine an Internet Protocol (IP) address or other identifying information associated with the first client computing device may map the IP address or other identifying information to a geographical location.

After determining the geographical location associated with the first client computing device, the computing system may determine a geographical region that includes the geographical location. For instance, if the IP address indicates that the first client computing device resides in or is otherwise associated with Seattle, Washington, USA, the computing system may determine that the first client computing device is associated with a region “North America”, “USA”, “Washington state”, or the like. It is to be appreciated that while example regions are described, the regions may correspond to any level of granularity.

After determining the region that includes the geographical location of the first client computing device, the computing system may determine data that is associated with this region to determine which content items to present on the UI provided to the first client computing device and/or a manner (e.g., an order) in which to present these content items. For instance, using the example of a predefined set of content items associated with a sales event or other promotion, the computing system may determine an order within a carousel or other UI element in which to present the respective icons of the respective icons within the carousel or other UI element.

In some instances, the computing system may determine sales data associated with the region in order to determine the order in which to present the icons. For instance, the computing system may include a sales database that stores information regarding a level of sales of individual content items, categories of content items, and so forth across different geographical regions. This sales database may be updated periodically (e.g., every fifteen minutes, every hour, every day, etc.) and the sales data may be based on any metric or combination of metrics representing a level of sales of each content item. For instance, the sales database may maintain, for each content item and/or content-item category, an indication of a level of sales that is based on sales of the game within a most recent predefined period of time or the like. In some instances, the sales data may also include preorder data indicating a number of users that requested to acquire a respective content item regardless of whether that content item has actually been released.

After determining the sales data for each content item of the set of content items, the computing system may determine an order in which to present the corresponding icons on the UI based at least in part on this sales data. For instance, the computing system may generally present icons corresponding to content items having relatively high level of sales first and/or more prominently, followed by icons associated with lower-selling content items, and so forth. In other instances, the computing system may generate a UI that begins with icons corresponding to lower-selling content items. In still other instances, the computing system may determine, for each content item, which sales level of multiple sales levels that is associated with the content item, such as a “high level of sales”, “medium level of sales”, and a “low level of sales”. The computing system may then present the content items associated with the high level of sales first, followed by content items associated with the medium level of sales, followed by content items associated with the low level of sales. Within each of these sales levels, however, the computing system may randomize the display of the icons, thereby maintaining some amount of obscurity regarding the exact level of sales of each content item relative to one another. Regardless of the exact manner in which the icons are organized based on the sales data, the computing system may generate and send, to the first client computing device, a UI that lists the higher-selling content items first and/or more prominently, such that the user of the first client computing device is able to first view content items that are most popular in the region of the user. In other instances, the computing system may generate the UI in the opposite manner, such that the user is able to first view content items that are less popular in the region of the user.

In addition to the above, a second user may send a request for information regarding the content items to the computing system while operating a second client computing device associated with a second geographical location. In response to receiving this request, the computing system may determine the second geographical location associated with the second client computing device, such as by mapping an IP address associated with the second client computing device to a second region that includes the second geographical location. Again, the computing system may then use data associated with this second region to determine an order or other manner in which to present the content items of the set of content items. For instance, the computing system may determine sales data of the individual content items in the second region of the second user and may use this sales data to order and/or otherwise generate the UI to provide to the second client computing device.

For instance, the computing system may generate and send, to the second client computing device, a UI that lists the higher-selling content items in the second region first and/or more prominently, such that the user of the first client computing device is able to first view content items that are most popular in the region of the second user. In other instances, the computing system may generate the UI in the opposite manner, such that the user is able to first view content items that are less popular in the region of the second user. By utilizing the sales data of the individual regions, the first and second users are able to view content items that are more closely tailored to the current interests of the broader communities of the respective regions of the first and second users.

While the above examples describe ordering the content items based on region-specific sales data, it is to be appreciated that the computing system may use one or more other criteria in generating these UIs. For instance, the computing system may determine preferences associated with the user of the current client computing device, a consumption history of the user, and/or the like. For instance, if a particular user often plays role-player games, then games associated with this category may be weighted more heavily than other games and, thus, may be listed closer to the top of the UI and/or more prominently than if the game were associated with a different category.

In addition, while the above example describes ordering content-item icons within a carousel or other UI element, it is to be appreciated that the carousels or UI elements themselves may be ordered based on sales data and/or one or more other criteria. For instance, envision that the computing system is currently running as sales event that includes at least two categories of games. If a first category of the two categories has greater sales data than a second category of the two categories within a first region, then computing devices within that first region may receive a UI that include the carousel listing content items of the first category first and/or more prominently than the carousel listing content items of the second category. If, however, the second category has greater sales data than the first category within a second region, then computing devices within that second region may receive a UI that include the carousel listing content items of the second category first and/or more prominently than the carousel listing content items of the first category. In these instances, the content items within the first and second carousels may also be ordered and/or presented in a manner that is also based on the sales data and/or other criteria. Further, while this example describes two carousels or UI elements, it is to be appreciated that the UIs may include any number of carousels or UI elements associated with respective categories, which may be ordered and/or displayed based on the sales data, user preferences, and/or the like.

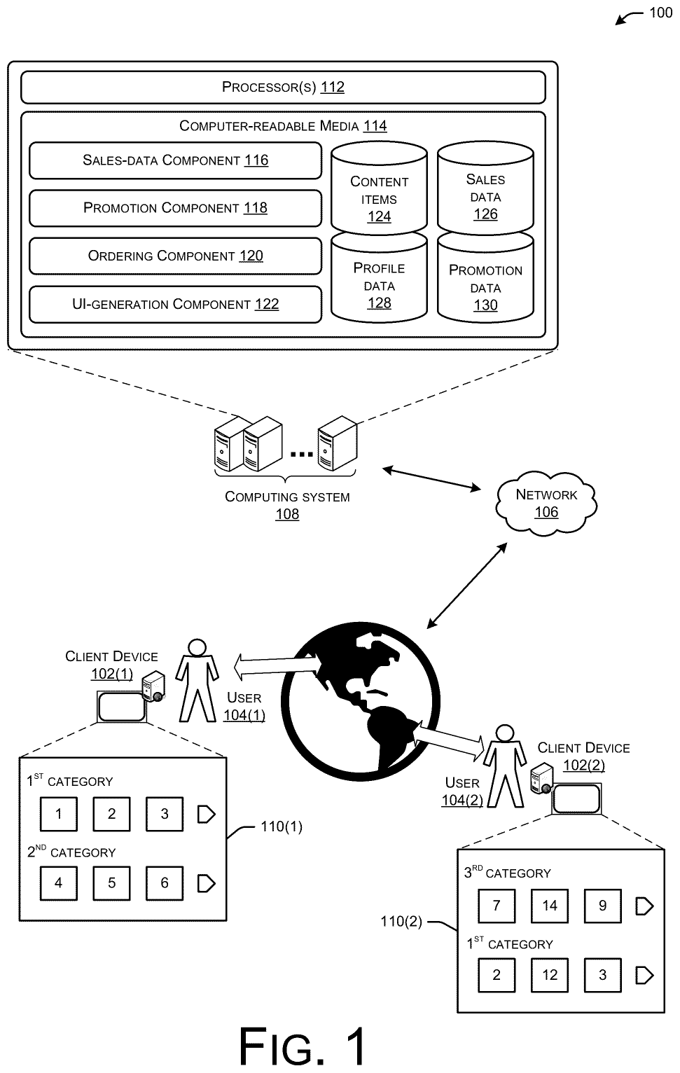

The techniques introduced above are described with reference to FIGS. 1-6. The disclosed techniques may be implemented, at least in part, by a remote computing system that distributes content items (e.g., video games, movies, television shows, songs, game titles, etc.) to client devices of a user community (e.g., as part of a video-game service, movie service, song service, etc.). It is to be appreciated that while these techniques are described with reference to games (e.g., video games), these techniques may apply to any other type of content items, such as books, movies, videos, songs, or the like.

FIG. 1 is a diagram illustrating an example environment 100 that includes a first client computing device (or “client device”) 102(1) operated by a first user 104(1) as well as a second client computing device 102(2) operated by a second user 104(2). As illustrated, each of the example users 104(1) and 104(2) reside at different geographical locations. Also as illustrated, each client computing device 102(1) and 102(2) couple over a network 106 to a remote computing system 108 that is configured to provide games and/or other content items to the client computing devices (collectively, “devices 102”). In some instances, the computing system 108 may determine sales data that is unique to individual geographical locations associated with the client computing devices 102 and may use this sales data for generating content-item recommendations for respective users (collectively, “users 104”).

The client devices 102 may be implemented as any suitable type of computing device configured to execute content items, such as video games, movies, songs, and/or the like. The client devices 102 may comprise, without limitation, a personal computer (PC), a desktop computer, a laptop computer, a mobile phone (e.g., a smart phone), a tablet computer, a portable digital assistant (PDA), a wearable computer (e.g., virtual reality (VR) headset, augmented reality (AR) headset, smart glasses, etc.), an in-vehicle (e.g., in-car) computer, a television (smart television), a set-top-box (STB), a game console, a music player, a voice-controlled assistant, and/or any similar computing device. In some instances, the client devices 102 may include integral displays, while in other instances the client devices may couple to respective display devices. In addition, the client devices 102 may communicate with the remote computing system (“computing system”) 108 over the computer network 106. The computer network 106 may represent and/or include, without limitation, the Internet, other types of data and/or voice networks, a wired infrastructure (e.g., coaxial cable, fiber optic cable, etc.), a wireless infrastructure (e.g., radio frequencies (RF), cellular, satellite, etc.), and/or other connection technologies. The computing system 108 may, in some instances be part of a network-accessible computing platform that is maintained and accessible via the computer network 106. Network-accessible computing platforms such as this may be referred to using terms such as “on-demand computing”, “software as a service (SaaS)”, “platform computing”, “network-accessible platform”, “cloud services”, “data centers”, and so forth.

In some embodiments, the computing system 108 acts as, or has access to, a video game platform that implements a video game service to distribute (e.g., download, stream, etc.) video games (or any other type of content item) to the client devices, such as the client device 102. In an example, each client device may install a client application thereon. The installed client application may be a video-game client (e.g., gaming software to play video games). A client device 102 with an installed client application may be configured to download, stream, or otherwise receive programs (e.g., video games, and content thereof) from the computing system 108 over the computer network 106. Any type of content-distribution model can be utilized for this purpose, such as a direct purchase model where programs (e.g., video games) are individually purchasable for download and execution on a client device 102, a subscription-based model, a content-distribution model where programs are rented or leased for a period of time, streamed, or otherwise made available to the client devices. Accordingly, an individual client device 102 may include one or more installed video games that are executable by loading the client application.

The client device 102 may be used to register with, and thereafter login to, a video game service. A user may create a user account for this purpose and specify/set credentials (e.g., passwords, PINS, biometric IDs, etc.) tied to the registered user account. As a plurality of users interact with the video game platform (e.g., by accessing their user/player profiles with a registered user account, playing video games on their respective client devices, etc.), the client devices send data to the remote computing system 108. The data sent to the remote computing system 108, for a given client device 102, may include, without limitation, user input data, video game data (e.g., game performance statistics uploaded to the remote system), social networking messages and related activity, identifiers (IDs) of the video games played on the client device 102, and so on. This data can be streamed in real-time (or substantially real-time), sent the remote system 108 at defined intervals, and/or uploaded in response to events (e.g., exiting a video game). This data may be used to determine a gameplay history of the user of the client device 102, preferences of the user, or the like, which may be used to determine which game titles to recommend to the user and/or a manner (e.g., an order) in which to recommend the game titles to the user, as introduced above and discussed in further detail below.

For instance, the user 104(1) may operate the client device 102(1) to navigate to a webpage or the like associated with the computing system 108 and, in response, the computing system 108 may cause the client device 102(1) to present a user interface (UI) 110(1) on a display of the client device 102(1). In some instances, this UI 110(1) may include information regarding one or more video games or other content items available for acquisition by the user 104(1) and from the computing system 108. For instance, the UI 110(1) may include icons associated with the respective game titles, with these icons being selectable by the user 104(1) to learn more information regarding a respective game title, request to acquire the respective game title, and so forth. In some instances, and as illustrated, the UI 110(1) may include a first carousel of icons for games associated with a first category (e.g., a first game category) and a second carousel of icons for games associated with a second category (e.g., a second game category).

In some instances, the categories and/or the game titles may be selected based on criteria associated with the user 104(1), the geographical location associated with the user 104(1), and/or the like. For instance, the computing system 108 may use information such as sales data for game titles, preferences of the user, gameplay history, and/or the like for selecting the game titles and/or the categories to present to the user 104(1). In addition, or in the alternative, the computing system 108 may use this information (e.g., sales data, preferences, gameplay history, etc.) to determine an order or other manner in which to present a set of game titles, such as those game titles associated with a particular sales event or other promotion. Of course, while two icon carousels are illustrated, it is to be appreciated that any other number may be utilized and that tools other than icon carousels may be used to present the icons. In addition, it is to be appreciated that while this example describes ordering icons based on one or more criteria, it is to be appreciated that the techniques may cause certain icons to be more prominent on the UI 110(1) in ways other than ordering, such as by making certain icons larger, highlighting certain icons, or so forth.

In one example, for instance, the computing system 108 may use sales data associated with a region in which the user 104(1) and/or client device 102(1) reside in order to determine an order in which to present the first and second carousels. For instance, the computing system 110(1) may use the sales data associated with the region of the user 104(1) to determine to present, on the UI 110(1), game titles associated with a first category first, followed by game titles associated with a second game category. Further, FIG. 1 illustrates that the UI 110(1) may utilize this region-based sales data to determine an order to present the game titles within the individual carousels. In one example, the UI 110(1) may list higher-selling games in the particular region of the user 104(1) prior to lesser-selling games. Given that the order of the game-title icons may be based on sales data, however, in some instances the order of these icons may differ based on the region associated with a particular user and/or client computing device operated by user.

FIG. 1, for instances, illustrates that the second user 104(2) operates the client device 102(2) in a region that differs from the region associated with the first device 102(1) and user 104(1). In response to the user navigating to the webpage, client application provided by the computing system 108, or the like, the client device 102(2) may present a second UI 110(2). Again, the UI 110(2) may order the carousels and game-title icons therein based at least in part on sales data associated with the region of the user 104(2). Here, based on this region-specific sales data, the UI 110(2) lists an icon carousel associated with a third game category first, followed by an icon carousel associated with the first game category, and so forth. Further, and as illustrated, the icons of the game titles may be ordered in a manner that differs from the order of the icons on the UI 110(1). For instance, while the first UI 110(1) lists icons in the first game category in the order of “game 1”, “game 2”, “game 3”, and so forth, the second UI 110(2) lists the icons in the second category in order of “game 2”, “game 12”, game “3”, and so forth, reflecting the different sales data for the different regions.

FIG. 1 illustrates example components of the computing system 108 for generating the respective UIs 110(1) and 110(2). As illustrated, the computing system 108 may comprise one or more processors 112 (e.g., central processing unit(s) (CPU(s)) and computer-readable media 114, as well as components stored thereon for generating UIs, such as example UIs 110(1) and 110(2). The computer-readable media 114 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information, and which can be accessed by a computing device. The computer-readable media 114 may be implemented as computer-readable storage media (“CRSM”), which may be any available physical media accessible by the processor(s) 112 to execute instructions stored on the computer-readable media 114. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information, which can be accessed by the processor(s) 112.

As illustrated, the computer-readable media 114 may store or otherwise have access to a sales-data component 116, a promotion component 118, an ordering component 120, and a UI-generation component 122. In addition, the media 114 may store a library of content items 124, sales data 126 indicating sales associated with these content items, profile data 128 storing information associated with users of the computing system 108, and promotion data 130 indicating which content items are associated with a particular sales event or other promotion.

The sales-data component 116 may function to track and store the sales data 126 as content items are sold or otherwise acquired over time. It is to be appreciated that the sales data described herein may correspond to any measurement that represents how many times or how often a content item was purchased, rented, leased, downloaded, or otherwise acquired or consumed, without regards to whether a consumer of the item paid or otherwise gave something of value for consumption of the content item. For instance, the sales data may represent a count of an amount of times a particular content item has been acquired, a total cost volume associated with sales or the item, and/or the like. In addition, the sales-data component may store information such as a region-specific sales data for each of the content items 124. The sales-data component may use any level of granularity when determining regions. For instance, the sales-data component 116 may store sales data in association with individual cities, states, countries, continents, or the like.

The promotion component 118, meanwhile, may function to determine which content items associated with a particular sales event or other type of promotion and may store one or more corresponding indications as the promotion data 130. For instance, upon an operator of the remote system 108 determining that a particular set of the content items 124 are to be associated with a particular promotion, the promotion component 118 may store, as the promotion data 130, an indication that these content items are associated with the particular promotion.

The ordering component 120 may function to determine an order of icons and/or item categories for a particular UI based at least in part on the sales data 126, with this order being used by the UI-generation component 122 to generate a corresponding UI for presentation on a client device. For example, upon a particular user sending a request for information regarding a particular promotion (e.g., by using a client device to navigate to a webpage, mobile-application page, or other location associated with the promotion), the ordering component 120 may first determine a region associated with the client device before determining sales data associated with each of the content items associated with the particular promotion. This information may then be used to generate an order or manner in which to present icons associated with these content items. The ordering component 120 may then provide an indication of this order to the UI-generation component 122, which may then generate the UI and provide the UI for presentation on the client device.

To provide an example, envision that the user 104(1) navigates the client device 102(1) to a webpage associated with a particular promotion offered by the computing system 108. In response to receiving this request, the ordering component 120 may determine a region associated with the user 104(1) and/or the client device 102(1). For example, the ordering component 120 may determine an Internet Protocol (IP) address associated with the request of the client device 102(1) and may map this IP address to a geographical location. In another example, the ordering component 120 may determine a location associated with the user 104(1) and/or client device 102(1) as stored in the profile data 128 (e.g., in instances where the user 104(1) is “signed in”). Of course, while a few examples are provided, it is to be appreciated that the location of the user 104(1) and/or device 102(1) may be determined in any other manner. Regardless of how this location is determined, the ordering component 120 may then determine a region that includes this geographical location and may determine, for each content item associated with the promotion, sales data for the respective content item within the determined region.

In some instances, the ordering component 120 may use one or more additional criteria to determine this order. For instance, the ordering component may also determine, from the profile data 128, a user profile associated with the user 104(1) operating the client device 102(1) to determine information associated with the user 104(1) and may use this user-specific information in addition to the sales data to determine the order. For example, the ordering component 120 may determine preferences of the user 104(1) (e.g., tags or game categories indicated as preferred by the user), a consumption history of the user 104(1) at the system 108 or otherwise, demographic data associated with the user 104(1), and/or the like for use in determining the order of the icons within a UI.

Upon determining the order of the icons and, potentially, the order of the carousels or other UI elements, the ordering component 120 may provide an indication of this order to the UI-generation component 122, which may generate a corresponding UI. Here, for instance, the UI-generation component 122 may generate the UI 110(1) and may send this UI 110(1) for presentation on the client device 102(1). Here, the UI 110(1) includes the first category of games first (with “game 1” being listed first and followed by “game 2” and “game 3” and so forth), followed by the second category of games (with “game 4” being followed by “game 5” and “game 6” and so forth).

Next, envision that the user 104(2) navigates the client device 102(2) to the webpage associated with a particular promotion offered by the computing system 108. In response to receiving this request, the ordering component 120 may determine a region associated with the user 104(2) and/or the client device 102(2). For example, the ordering component 120 may determine an IP address associated with the request of the client device 102(2) and may map this IP address to a geographical location, may determine a location of the user 104(2) from the profile data 128, or the like. The ordering component 120 may then determine a region that includes this geographical location and may determine, for each content item associated with the promotion, sales data for the respective content item within the determined region.

In some instances, the ordering component 120 may use one or more additional criteria to determine this order. For instance, the ordering component may also determine a user profile associated with the user 104(2) operating the client device 102(2) to determine information associated with the user 104(2) and may use this user-specific information in addition to the sales data to determine the order. Again, the ordering component 120 may determine preferences of the user 104(2), a consumption history of the user 104(2) at the system 108 or otherwise, demographic data associated with the user 104(2), and/or the like for use in determining the order of the icons within a UI.

Upon determining the order of the icons and, potentially, the carousels or other UI elements, the ordering component 120 may provide an indication of this order to the UI-generation component 122, which may generate a corresponding UI. Here, for instance, the UI-generation component 122 may generate the UI 110(2) and may send this UI 110(2) for presentation on the client device 102(2). In this example, the UI 110(2) includes the third category of games first (with “game 7” being listed first and followed by “game 14” and “game 9” and so forth), followed by the first category of games (with “game 2” being followed by “game 12” and “game 3” and so forth). As will be appreciated, in this example the order of the carousels and the game titles listed therein differ between the UIs 110(1) and 110(2), potentially based on the differing sales data associated with the two geographical regions associated with the respective users and/or client devices.

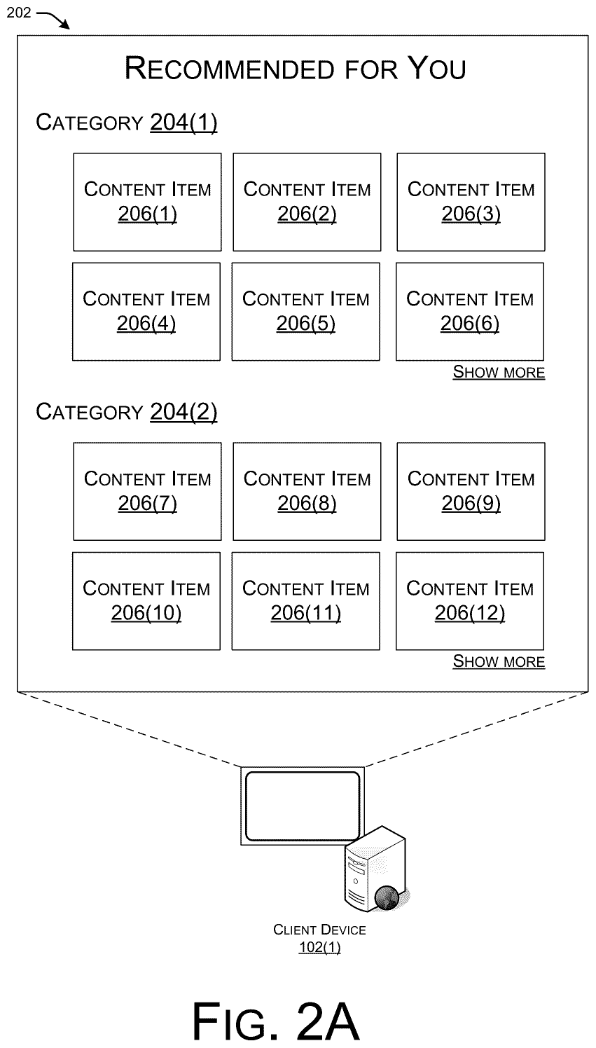

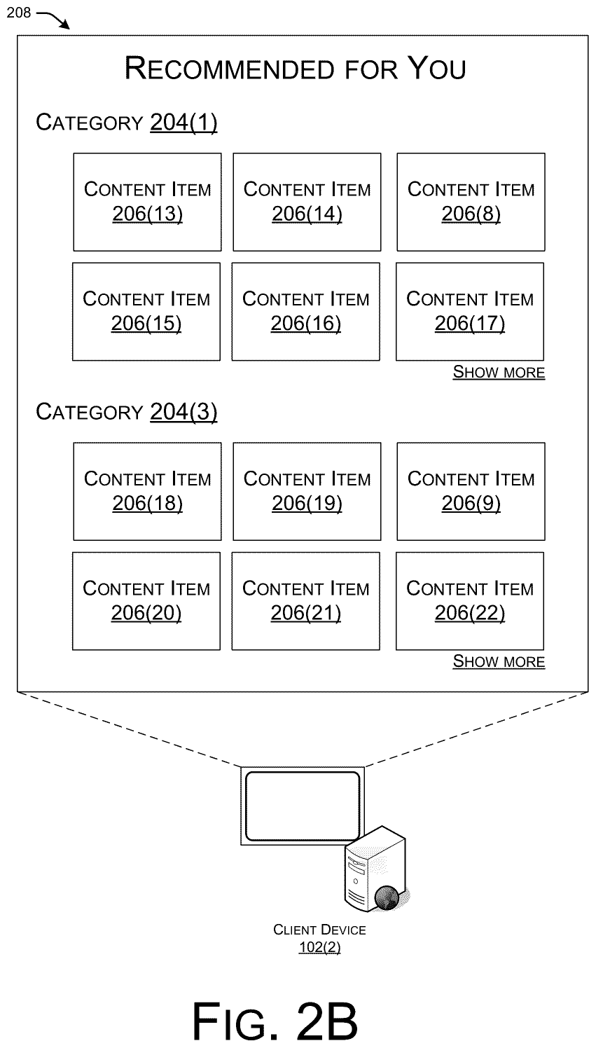

FIG. 2A illustrates additional details of an example UI 202 that the remote computing system 108 may provide to the first client computing device 102(1) located at the first geographical location. As illustrated, the UI may include content-item recommendations, which may be ordered and/or otherwise based on sales data associated with a region that includes the first geographical location, potentially in addition to one or more other criteria such as preferences or a consumption history of the respective user.

For example, the UI 202 may include respective icons 206(1), 206(2), 206(3), 206(4), 206(5), and 206(6) corresponding to content items associated with a first category 204(1), followed by icons 206(7), 206(8), 206(9), 206(10), 206(11), and 206(12) corresponding to content items associated with a second category 204(2). In some instances, the icons in each of the categories that are listed nearer the top and/or left (that is, the icons listed “first”) may correspond to content items having relatively higher sales than those icons listed further to the right and/or bottom, as well as relative to the icons that the UI 202 would display upon receiving a selection of the “see more” icon of the UI 202. In some instances, the ordering component 120 may determine, for each content item, which sales level of multiple sales levels that is associated with the content item, such as a “high level of sales”, “medium level of sales”, and a “low level of sales”. The UI 202 may then present the content items associated with the high level of sales first, followed by content items associated with the medium level of sales, followed by content items associated with the low level of sales. Within each of these sales levels, however, the ordering component 120 or the UI-generation component 122 may randomize the display of the icons, thereby maintaining some amount of obscurity regarding the exact level of sales of each content item relative to one another. Regardless of the exact manner in which the icons are organized based on the sales data, the UI-generation component 122 may generate and send, to the client computing device 102(1), a UI that lists the higher-selling content items first and/or more prominently, such that the user of the client computing device is able to first view content items that are most popular in the region of the user. In other instances, the computing system may generate the UI 202 in the opposite manner, such that the user is able to first view content items that are less popular in the region of the user.

In addition to ordering the icons according to popularity of the corresponding content items, in some instances the order of the categories themselves may be determined similarly. For instance, content items associated with the first category 204(1) may be relatively higher selling than content items associated with the second category 204(2) and, thus, this first category may be listed before the second category in the example UI 202. In some instances, meanwhile, this determination may alternatively, or additionally, be based on one or more other criteria, such as profile data associated with the user of the client device 102(1). In addition, it is to be appreciated that while this UI 202 orders icons based on sales data and/or other criteria, it is to be appreciated that other UIs may cause certain icons to be more prominent on the UI in ways other than ordering, such as by making certain icons larger, highlighting certain icons, or so forth.

FIG. 2B illustrates additional details of an example UI 208 that the remote computing system 108 may provide to the second client computing device 102(2) located at the first geographical location. As illustrated, the UI 208 may include content-item recommendations, which may be ordered and/or otherwise based on sales data associated with a region that includes the second geographical location, potentially in addition to one or more other criteria such as preferences or a consumption history of the respective user.

For example, the UI 208 may include respective icons 206(13), 206(14), 206(8), 206(15), 206(16), and 206(17) corresponding to content items associated with the first category 204(1). As will be appreciated, some of the icons listed first in the first category 204(1) are the same as those listed in the first category of the UI 202 (due to similar sales of these content items in the two regions), while other icons listed in the first category 204(1) of the UI 208 differ from the icons listed in the first category of the UI 202 (based on different sales between regions for these content items). In addition, the UI 208 may include icons 206(18), 206(19), 206(9), 206(20), 206(21), and 206(22) corresponding to content items associated with a third category 204(3). As will be appreciated, this third category 204(3) may be listed first (rather than the second category 204(2) from the UI 202) based on content items of this third category 204(3) selling more than content items of the second category 204(2) in the region of the user associated with the client device 102(2), based on preferences of this user, and/or the like. It will also be appreciated that some content items, such as the content item 206(9), may be associated with multiple categories.

As with the UI 202, in the UI 208 the icons in each of the categories that are listed nearer the top and/or left (that is, the icons listed “first”) may correspond to content items having relatively higher sales than those icons listed further to the right and/or bottom, as well as relative to the icons that the UI 208 would display upon receiving a selection of the “see more” icon of the UI 208. In some instances, the ordering component 120 may determine, for each content item, which sales level of multiple sales levels that is associated with the content item, such as a “high level of sales”, “medium level of sales”, and a “low level of sales”. The UI 208 may then present the content items associated with the high level of sales first, followed by content items associated with the medium level of sales, followed by content items associated with the low level of sales. Within each of these sales levels, however, the ordering component 120 or the UI-generation component 122 may randomize the display of the icons, thereby maintaining some amount of obscurity regarding the exact level of sales of each content item relative to one another. Regardless of the exact manner in which the icons are organized based on the sales data, the UI-generation component 122 may generate and send, to the client computing device 102(2), a UI that lists the higher-selling content items first and/or more prominently, such that the user of the client computing device is able to first view content items that are most popular in the region of the user. In other instances, the computing system may generate the UI 208 in the opposite manner, such that the user is able to first view content items that are less popular in the region of the user.

In addition to ordering the icons according to popularity of the corresponding content items, in some instances the order of the categories themselves may be determined similarly. For instance, content items associated with the first category 204(1) may be relatively higher selling than content items associated with the third category 204(3) and, thus, this first category may be listed before the third category in the example UI 208. In some instances, meanwhile, this determination may alternatively, or additionally, be based on one or more other criteria, such as profile data associated with the user of the client device 102(2). In addition, it is to be appreciated that while this UI 208 orders icons based on sales data and/or other criteria, it is to be appreciated that other UIs may cause certain icons to be more prominent on the UI in ways other than ordering, such as by making certain icons larger, highlighting certain icons, or so forth.

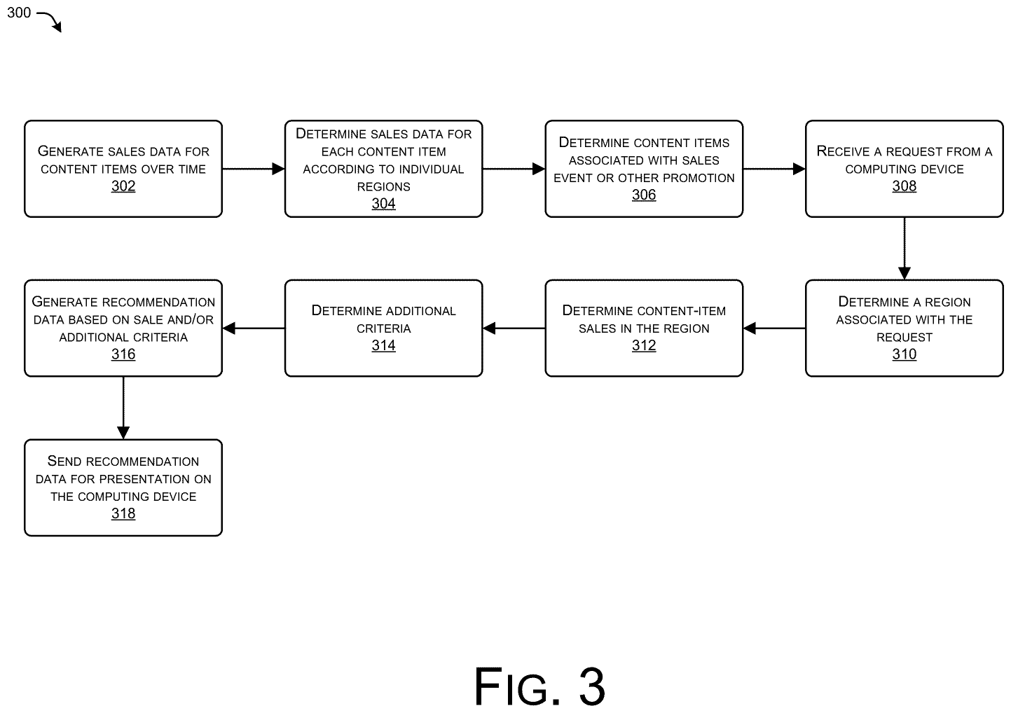

FIG. 3 illustrates a flow diagram of an example process 300 for generating content-item recommendations based on sales data and/or one or more other factors. This process, and each process described herein, is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some instances, the computing system 108 may be configured to perform some or all of the operations, although in other instances other devices may additionally or alternatively perform some or all of the operations. For instance, some or all of the techniques described herein may be performed on the client devices themselves in some instances.

At an operation 302, the remote computing system 108 generates sales data for content items over time. For instance, as users of a user community operate their respective client devices to acquire content items, the computing system 108 may update the data indicating the amount of these sales. In some instances, the computing system 108 may store information associated with each acquisition, such as an indication of a user or user profile associated with the acquisition, a location (e.g., region) associated with the user and/or client device that made the acquisition, and so forth. At an operation 304, the computing system may determine sales data for each content item according to individual regions. For instance, the sales-data component 116 may generate data indicating a number of acquisitions of each content item on a per-region basis.

At an operation 306, the computing system 108 may determine a set of content items associated with a sales event or other promotion. For instance, upon an operator of the remote computing system 108 indicating that a set of content items are to be associated with a particular sales event or promotion, the promotion component 118 may store this indication as the promotion data 130.

At an operation 308, the computing system 108 may receive a request for information regarding the sales event or promotion in response to, for example, a user operating a client device to navigate to a webpage or other content location associated with the sales event or promotion. In response and at an operation 310, the computing system 108 may determine a region associated with the request. The computing system 108 may determine a region associated with the request in any number of ways. In one example, the computing system 108 may determine an IP address or other identifier of the client device and may map this IP address or other identifier a geographical location. In other instances, the computing system may determine a user profile associated with a user operating the client device and may determine a prestored geographical location associated with the user profile. Of course, while two examples have been given, it is to be appreciated that the computing system 108 may determine the region of the user and/or the client device in any other manner.

At an operation 312, the computing system 108 may determine sales of the content items associated with the sales event or other promotion within the determined region. For instance, if the region is determined as “USA”, then the computing system 108 may determine, for each content item associated with the sales event or promotion, a number of sales of the respective content item in the USA. At an operation 314, the computing system 108 may determine one or more additional criteria for use in determining an order in which to present icons corresponding to the content items associated with the sales event or other promotion. As noted above, these additional criteria may comprise item categories preferred by the user, a consumption history of the user, a current time of day, and/or the like.

At an operation 316, the computing system 108 generates recommendation data based on the regional sales data determined at the operation 312 and/or the additional criteria determined at the operation 316. For instance, the computing system 108 may generate a UI similar to the UIs 202 and 208 discussed above, in which icons corresponding to higher-selling content items in the region of the user are presented first or otherwise more prominently on the UI. At an operation 318, the computing system 108 may send the recommendation data for presentation on the client computing device. For instance, the computing system may send data for presenting the UI on the client computing device.

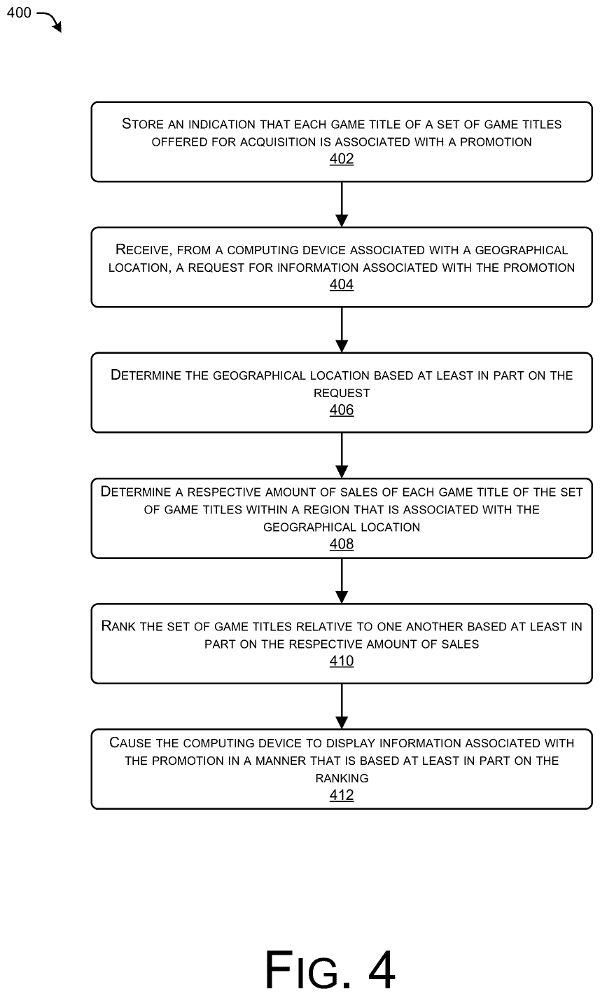

FIG. 4 illustrates a flow diagram of an example process 400 for generating game-title recommendations based on sales data and/or one or more other factors. This process may be performed by the remote computing system 108, a client device, or any other computing device. At an operation 402, the computing system 108 may store an indication that each game title of a set of game titles offered for acquisition is associated with a promotion. For instance, the promotion component may store the promotion data 130 indicating each game title that is associated with a particular promotion, as described above.

At an operation 404, the computing system 108 may receive, from a computing device associated with a geographical location, a request for information associated with the promotion. This may represent, for instance, a user operating the computing device to navigate to a webpage associated with the promotion, to a portion of a client application provided by the system 108 that is associated with the promotion, or the like.

At an operation 406, the computing system 108 may determine the geographical location based at least in part on the request. For instance, the remote computing system may determine an IP address of the computing device and may map this IP address to the geographical location. In another example, the computing system may determine the geographical location by analyzing a user profile associated with a user that is currently signed into an account with the computing system 108.

At an operation 408, the computing system 108 may determine a respective amount of sales of each game title of the set of game titles within a region that is associated with the geographical location. For instance, the sales-data component 116 may analyze the sales data 126 to determine sales of the content items on per-region basis. In some instances, determining the respective amount of sales comprises determining a respective amount of preorders of at least one game title of the set of game titles within the region, and wherein the ranking is further based at least in part on the respective amount of preorders. Furthermore, in some instances determining the respective amount of sales comprises determining the respective amount of sales from a sales database storing sales information associated with respective game titles, and the process may further comprise updating the sales database based on recent sales data at a predefined periodicity, such as every fifteen minutes, every hour, every day, or so forth.

At an operation 410, the computing system 108 may rank the set of game titles relative to one another based at least in part on the respective amount of sales. This may include determining a discrete order of the game titles based on sales, determining a respective sales level (e.g., low, medium, high) for each game title, or the like. In some instances, this ranking may comprise associating each game title of the set of game titles with a corresponding level of sales of multiple levels of sales, and the causing may comprise causing the computing device to display respective information associated with each game title of the set of game titles in an order beginning with one or more game titles associated with a highest level of sales and ending with one or more game titles associated with a lowest level of sales relative to the presented game titles.

At an operation 412, the computing system 108 may cause the computing device to display information associated with promotion in a manner that is based at least in part on the ranking. For instance, the ordering component 120 may determine an order in which to present the game titles, with this order being used by the UI-generation component to generate and send a UI to the computing device. In some instances, this operation may comprise causing the computing device to display respective information associated with each game title of the set of game titles in an order beginning with one or more game titles associated with the highest amount of sales relative to other game titles of the set of game titles. In other instances, this operation may comprise causing the computing device to display a first carousel of icons corresponding to game titles of the set of game titles that are associated with a first game category and a second carousel of icons corresponding to game titles of the set of game titles that are associated with a second game category, wherein the first carousel of icons is ordered based at least in part on the ranking and the second carousel is ordered based at least in part on the ranking. In these latter instances, the process 400 may further comprise determining an order in which to present at least the first carousel and the second carousel relative to one another based on one or more criteria, wherein the one or more criteria comprise a preference of a user associated with the computing device, a gameplay history of the user, or sales data associated with the first game category and the second game category. As discussed above, while this example describes two carousels or other UI elements, it is to be appreciated that a UI may include any number of carousels or other UI elements, which may be presented in an order or other manner based at least in part on regional sales data and/or other criteria.

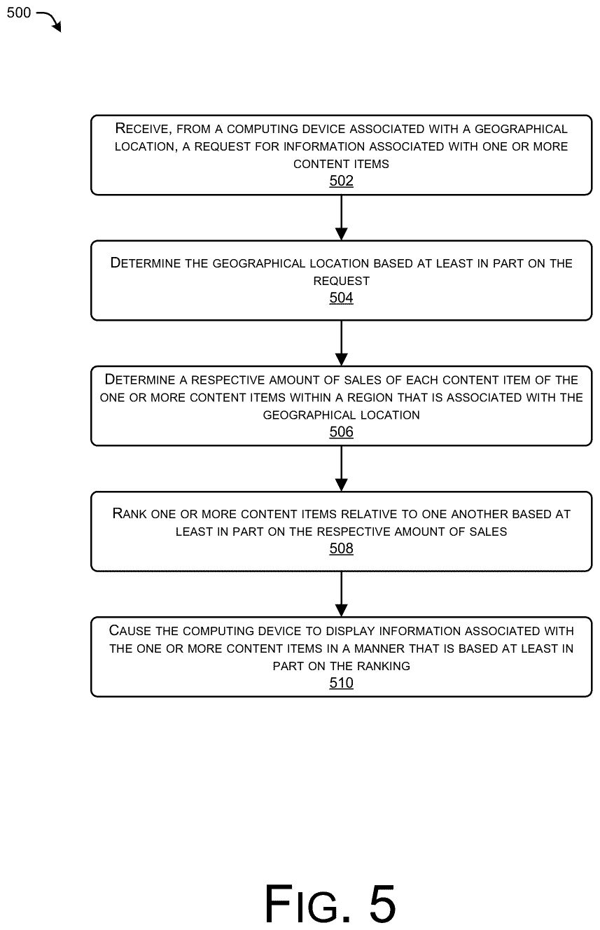

FIG. 5 illustrates a flow diagram of another example process 500 for generating content-item recommendations based on sales data and/or one or more other factors. This process may be performed by the remote computing system 108, a client device, or any other computing device. At an operation 502, the computing system 108 may receive, from a computing device associated with a geographical location, a request for information associated with one or more content items. This may represent, for instance, a user operating the computing device to navigate to a webpage associated with the content items, to a portion of a client application provided by the system 108 that is associated with the content items, or the like.

At an operation 504, the computing system 108 may determine the geographical location based at least in part on the request. For instance, the remote computing system may determine an IP address of the computing device and may map this IP address to the geographical location. In another example, the computing system may determine the geographical location by analyzing a user profile associated with a user that is currently signed into an account with the computing system 108.

At an operation 506, the computing system 108 may determine a respective amount of sales of each content item of the set of content items within a region that is associated with the geographical location. For instance, the sales-data component 116 may analyze the sales data 126 to determine sales of the content items on per-region basis. In some instances, determining the respective amount of sales comprises determining a respective amount of preorders of at least one content item of the one or more content items within the region, and wherein the ranking is further based at least in part on the respective amount of preorders. Furthermore, in some instances determining the respective amount of sales comprises determining the respective amount of sales from a sales database storing sales information associated with respective content items, and the process may further comprise updating the sales database based on recent sales data at a predefined periodicity, such as every fifteen minutes, every hour, every day, or so forth.

At an operation 508, the computing system 108 may rank the one or more content items relative to one another based at least in part on the respective amount of sales. This may include determining a discrete order of the game titles based on sales, determining a respective sales level (e.g., low, medium, high) for each content item, or the like. In some instances, this ranking may comprise associating each content item with a corresponding level of sales of multiple levels of sales, and wherein the causing comprises causing the computing device to display respective information associated with each content item in an order beginning with one or more content items associated with a highest level of sales and ending with one or more content items associated with a lowest level of sales relative to the presented game titles.

At an operation 510, the computing system 108 may cause the computing device to display information associated with one or more content items in a manner that is based at least in part on the ranking. For instance, the ordering component 120 may determine an order in which to present the content items, with this order being used by the UI-generation component to generate and send a UI to the computing device. In some instances, this operation may comprise causing the computing device to display respective information associated with each content item of the one or more content items in an order beginning with one or more content items associated with the highest amount of sales relative to other content items of the one or more content items. In other instances, this operation may comprise causing the computing device to display a first carousel of icons corresponding to content items that are associated with a first category and a second carousel of icons corresponding to content items that are associated with a second category, wherein the first carousel of icons is ordered based at least in part on the ranking and the second carousel is ordered based at least in part on the ranking. In these latter instances, the process 500 may further comprise determining an order in which to present at least the first carousel and the second carousel relative to one another based on one or more criteria, wherein the one or more criteria comprise a preference of a user associated with the computing device, a consumption history of the user, or sales data associated with the first category and the second category. Again, while this example describes two carousels or other UI elements, it is to be appreciated that a UI may include any number of carousels or other UI elements, which may be presented in an order or other manner based at least in part on regional sales data and/or other criteria.

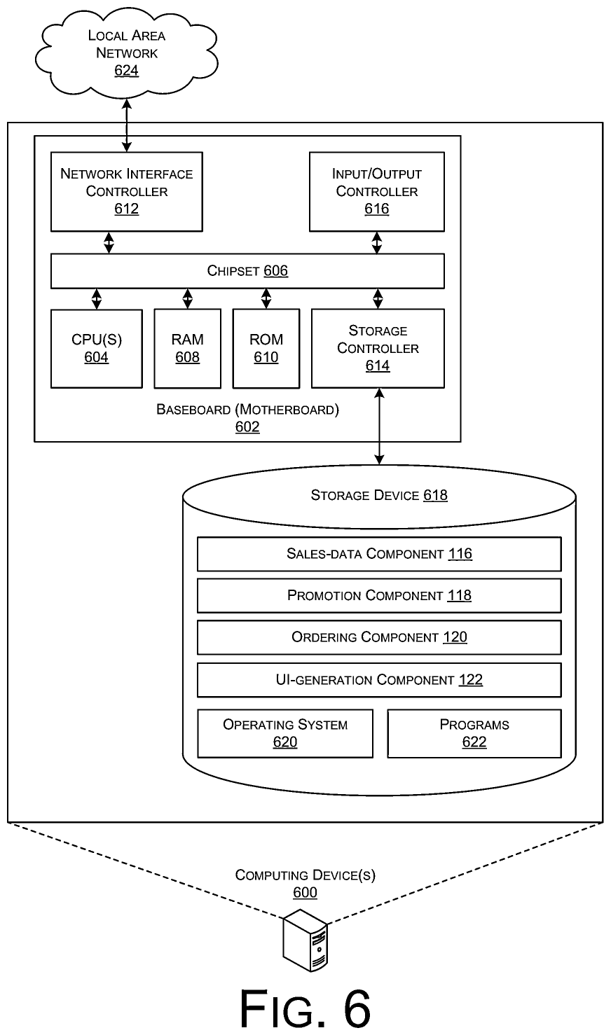

FIG. 6 is a computer architecture diagram showing an illustrative computer hardware architecture for implementing a device 600 that can be utilized to implement aspects of the various technologies presented herein. The computing system 108 and/or the client devices 102 described herein may include some or all of the components discussed below with reference to the device 600.

The computing resources described herein may be provided by a cloud computing network, data center, or the like can be data processing resources such as VM instances or hardware computing systems, database clusters, computing clusters, storage clusters, data storage resources, database resources, networking resources, and others. Some of the devices 600 can also be configured to execute a resource manager capable of instantiating and/or managing the computing resources. In the case of VM instances, for example, the resource manager can be a hypervisor, or another type of program configured to enable the execution of multiple VM instances on a single server device 600. Devices 600 in a data center can also be configured to provide network services and other types of services.

The device 600 includes a baseboard 602, or “motherboard,” which is a printed circuit board to which a multitude of components or devices can be connected by way of a system bus or other electrical communication paths. In one illustrative configuration, one or more central processing units (CPUs) 604 operate in conjunction with a chipset 606. The CPUs 604 can be standard programmable processors that perform arithmetic and logical operations necessary for the operation of the device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the device 600. The chipset 606 can further provide an interface to a computer-readable storage medium such as a read-only memory (ROM) 610 or non-volatile RAM (NVRAM) for storing basic routines that help to startup the device 600 and to transfer information between the various components and devices. The ROM 610 or NVRAM can also store other software components necessary for the operation of the device 600 in accordance with the configurations described herein.

The device 600 can operate in a networked environment using logical connections to remote computing devices and computer systems through a network, such as a local area network 624. The chipset 606 can include functionality for providing network connectivity through a Network Interface Card (NIC) 612, such as a gigabit Ethernet adapter. The NIC 612 is capable of connecting the device 600 to other computing devices over the network. It should be appreciated that multiple NICs 612 can be present in the device 600, connecting the computer to other types of networks and remote computer systems.

The device 600 can be connected to a storage device 618 that provides non-volatile storage for the computer. The storage device 618 can store an operating system 620, programs 622, and data, which have been described in greater detail herein. The storage device 618 can be connected to the device 600 through a storage controller 614 connected to the chipset 606. The storage device 618 can consist of one or more physical storage units. The storage controller 614 can interface with the physical storage units through a serial attached SCSI (SAS) interface, a serial advanced technology attachment (SATA) interface, an FC interface, or other type of interface for physically connecting and transferring data between computers and physical storage units.

The device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The device 600 can further read information from the storage device 618 by detecting the physical states or characteristics of one or more particular locations within the physical storage units.

In addition to the mass storage device 618 described above, the device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the device 600.

In one embodiment, the storage device 618 or other computer-readable storage media is encoded with computer-executable instructions which, when loaded into the device 600, transform the computer from a general-purpose computing system into a special-purpose computer capable of implementing the embodiments described herein. These computer-executable instructions transform the device 600 by specifying how the CPUs 604 transition between states, as described above. According to one embodiment, the device 600 has access to computer-readable storage media storing computer-executable instructions which, when executed by the device 600, perform the various processes described above with regard to FIGS. 3-5. The device 600 can also include computer-readable storage media having instructions stored thereupon for performing any of the other computer-implemented operations described herein.

The device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the device 600 might not include all of the components shown in FIG. 6, can include other components that are not explicitly shown in FIG. 6, or might utilize an architecture completely different than that shown in FIG. 6.

The device 600 may also store, in the storage device 618, the sales-data component 116, the promotion component 118, the ordering component 120, the UI-generation component 122, and/or additional elements described above with reference to FIGS. 1-5.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
storing an indication that each game title of a set of game titles offered for acquisition is associated with a promotion;
receiving, from a computing device associated with a geographical location, a request for information associated with the promotion;
determining the geographical location based at least in part on the request;
determining, for each game title of the set of game titles, a respective amount of sales of the game title within a region that is associated with the geographical location;
ranking game titles of the set of game titles relative to one another based at least in part on the respective amounts of sales; and
causing the computing device to display information associated with promotion in a manner that is based at least in part on the ranking.

2. The method as recited in claim 1, wherein the causing comprises causing the computing device to display respective information associated with each game title of the set of game titles in an order beginning with one or more game titles associated with a highest amount of sales relative to other game titles of the set of game titles.

3. The method as recited in claim 1, wherein the causing comprises causing the computing device to display a first carousel of icons corresponding to game titles of the set of game titles that are associated with a first game category and a second carousel of icons corresponding to game titles of the set of game titles that are associated with a second game category, and wherein the first carousel of icons is ordered based at least in part on the ranking and the second carousel is ordered based at least in part on the ranking.

4. The method as recited in claim 3, further comprising determining an order in which to present at least the first carousel and the second carousel relative to one another based on one or more criteria.

5. The method as recited in claim 4, wherein the one or more criteria comprise a preference of a user associated with the computing device, a gameplay history of the user, or sales data associated with the first game category and the second game category.

6. The method as recited in claim 1, wherein the ranking comprises associating each game title of the set of game titles with a corresponding level of sales of multiple levels of sales, and wherein the causing comprises causing the computing device to display respective information associated with each game title of the set of game titles in an order beginning with one or more game titles associated with a highest level of sales and ending with one or more game titles associated with a lowest level of sales.

7. The method as recited in claim 1, wherein the determining the respective amount of sales comprises determining a respective amount of preorders of at least one game title of the set of game titles within the region, and wherein the ranking is further based at least in part on the respective amount of preorders.

8. The method as recited in claim 1, wherein the determining the respective amount of sales comprises determining the respective amount of sales from a sales database storing sales information associated with respective game titles, and further comprising updating the sales database based on recent sales data at a predefined periodicity.

9. The method as recited in claim 1, wherein the determining the geographical location comprises determining an Internet Protocol (IP) address associated with the request and mapping the IP address to the geographical location.

10. A system comprising:
one or more processors; and
one or more computer-readable media storing computer-executable instructions that, when executed, cause the one or more processors to perform acts comprising:
receiving, from a computing device associated with a geographical location, a request for information associated with one or more content items;
determining the geographical location based at least in part on the request;
determining, for the one or more content items, a respective amount of sales of each content item within a region that is associated with the geographical location;
ranking the one or more content items relative to one another based at least in part on the respective amount of sales; and
causing the computing device to display information associated with the one or more content items in a manner that is based at least in part on the ranking.

11. The system as recited in claim 10, wherein the causing comprises causing the computing device to display respective information associated with each content item in an order beginning with one or more content items associated with a highest amount of sales relative to other ones of the content items.

12. The system as recited in claim 10, wherein the causing comprises causing the computing device to display a first carousel of icons corresponding to content items that are associated with a first category and a second carousel of icons corresponding to content items that are associated with a second category, and wherein the first carousel of icons is ordered based at least in part on the ranking and the second carousel is ordered based at least in part on the ranking.

13. The system as recited in claim 12, the acts further comprising determining an order in which to present at least the first carousel and the second carousel relative to one another based on one or more criteria.

14. The system as recited in claim 13, wherein the one or more criteria comprise a preference of a user associated with the computing device, a consumption history of the user, or sales data associated with the first category and the second category.

15. The system as recited in claim 10, wherein the ranking comprises associating each content item with a corresponding level of sales of multiple levels of sales, and wherein the causing comprises causing the computing device to display respective information associated with each content item in an order beginning with one or more content items associated with a highest level of sales and ending with one or more content items associated with a lowest level of sales.

16. The system as recited in claim 10, wherein the determining the respective amount of sales comprises determine a respective amount of preorders of at least one content item within the region, and wherein the ranking is further based at least in part on the respective amount of preorders.

17. The system as recited in claim 10, wherein the determining the respective amount of sales comprises determining the respective amount of sales from a sales database storing sales information associated with respective content items, and further comprising updating the sales database at a predefined periodicity based on recent sales data.

18. The system as recited in claim 10, wherein the determining the geographical location comprises determining an Internet Protocol (IP) address associated with the request and mapping the IP address to the geographical location.

19. One or more computer-readable media storing computer-executable instructions that, when executed, cause one or more processors to perform acts comprising:
receiving, from a computing device associated with a geographical location, a request for information associated with one or more content items;
determining the geographical location based at least in part on the request;
determining, for the one or more content items, a respective amount of sales of each content item within a region that is associated with the geographical location;
ranking the set of content items relative to one another based at least in part on the respective amount of sales; and
causing the computing device to display information associated with the one or more content items in a manner that is based at least in part on the ranking.

20. The one or more computer-readable media as recited in claim 19, wherein the causing comprises causing the computing device to display respective information associated with each content item in an order beginning with one or more content items associated with a highest amount of sales relative to other ones of the content items.
